(19) United States
(12) Patent Application Publication
(10) Pub. No.: US 2016/0165876 A1
(43) Pub. Date: Jun. 16, 2016

(54) TRAP FOR SNAKES AND SMALL ANIMALS

(71) Applicant: BURT ANDREW HERBERT, MANASSAS, VA (US)

(72) Inventor: BURT ANDREW HERBERT, MANASSAS, VA (US)

(21) Appl. No.: 14/572,142

(22) Filed: Dec. 16, 2014

(51) Int. Cl. A01M 23/04; A01M 23/06; A01M 23/08

(52) U.S. Cl. CPC A01M 23/04; A01M 23/08; A01M 23/06

(57) ABSTRACT

A trap for snakes and small animals includes an enclosure with a holding area. A hollow tube is pivotally mounted in the enclosure. The hollow tube pivots between a first tilted position which allows a snake or a small animal to enter a first end of the tube, and a second tilted position which allows the snake or small animal to exit a second end of the tube. The weight of the snake or small animal moving along the hollow tube from the first to the second end causes the tube to pivot between the first and second tilted positions. Once the snake or small animal has exited the second end of the tube and entered a holding area within the trap, the hollow tube pivots back to the first tilted position, which prevents the snake or small animal from escaping the holding area.

### BACKGROUND OF THE INVENTION

The invention is related to traps which are used to capture snakes, small animals and other reptiles and rodents. Many traps used for this purpose are complex and expensive to manufacture. Also, existing traps are not well configured to effectively trap snakes, given their elongated bodies and movement patterns.

What is needed is a trap that is inexpensive to produce, but which is configured so that it is effective in attracting and capturing snakes

### BRIEF DESCRIPTION OF THE DRAWINGS

FIG. 1 is a perspective view of a first embodiment of a trap for snakes and small animals;

FIG. 2 is top view of the trap illustrated in FIG. 1 with the ceiling removed;

FIG. 3 is a perspective view of a tube of the trap illustrated in FIGS. 1 and 2;

FIG. 4 is a cross-sectional view taken along Section Line IV-IV of FIG. 2 when the tube of the trap is in a first tilted position;

FIG. 5 is a cross-sectional view taken along Section Line IV-IV of FIG. 2 when the tube of the trap is in a second tilted position;

FIG. 6 is a cross-sectional view taken along Section Line IV-IV of FIG. 2 of an alternate embodiment when the tube of the trap is in a first tilted position;

FIG. 7 is a cross-sectional view taken along Section Line IV-IV of FIG. 2 of another alternate embodiment when the tube of the trap is in a first tilted position;

FIG. 8 is a plan view illustrating a trap positioned adjacent a wall of a building;

FIG. 9 is a perspective view of another embodiment of a trap for snakes and small animals;

FIG. 10 is a top view of the trap illustrated in FIG. 9 with the ceiling of the trap removed;

FIG. 11 is a top view of another embodiment of a trap for snakes and small animals with a top cover of the trap removed;

FIG. 12 is a side view of the trap illustrated in FIG. 11;

FIG. 13 is a sectional view of the trap illustrated in FIG. 11 taken along section line 13-13;

FIG. 14A is a sectional view of the trap illustrated in FIG. 11 taken along section line 14-14 with a tilting tube in a first position;

FIG. 14B is a sectional view of the trap illustrated in FIG. 11 taken along section line 14-14 with the tilting tube in a second position; and

FIG. 15 is a sectional view of the trap illustrated in FIG. 11 taken along section line 15-15.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

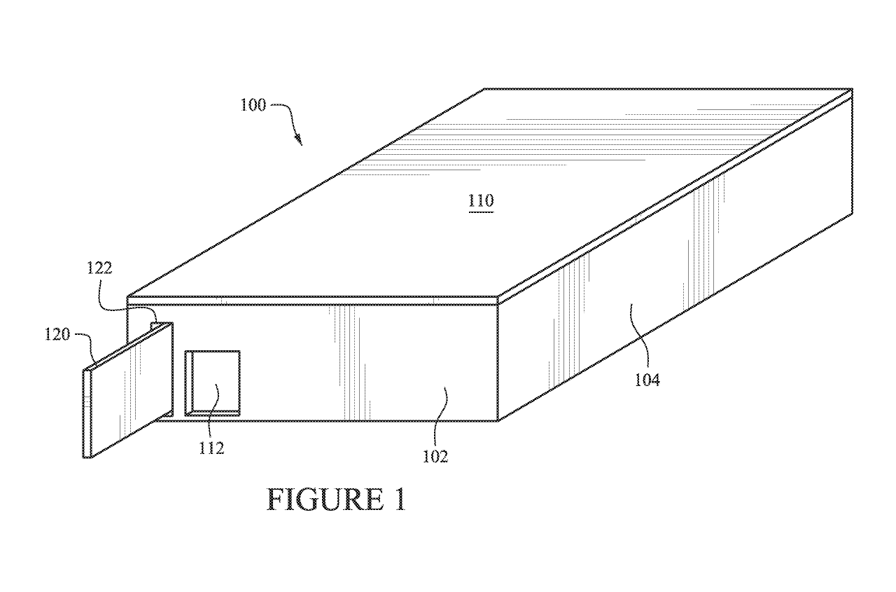

FIG. 1 illustrates a trap that is configured to capture and hold snakes and small animals. The trap 100 has an enclosure formed by a ceiling 110, sidewalls 102, 104 and a floor. An entrance aperture 112 is located in one of the sidewalls. For ease of explanation, the following description refers to the sidewall 102 having the aperture 112 as the front wall. However, this term is in no way intended to be limiting. FIG. 1 also illustrates that a guide plate 120 may be retractably provided in a guide plate aperture 122 on the front wall 102 of the trap 100. The purpose and use of the guide plate 120 is described in greater detail below.

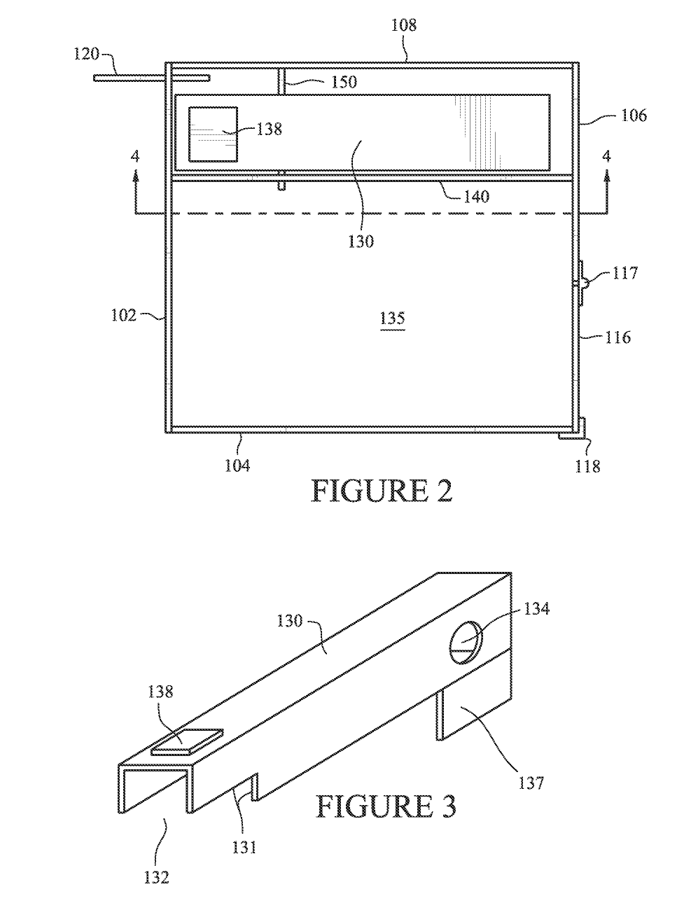

FIG. 2 is a top view of the trap 100 with the ceiling 110 removed so that the internal elements of the trap are visible. As shown in FIG. 2, an internal wall 140 is provided inside the enclosure. The internal wall 140 extends between the front wall 102 and a rear wall 106 of the enclosure. A holding area 135 is formed inside the enclosure by the floor, the ceiling, the internal wall 140 and the sidewalls 102, 104 and 106.

A hollow tube 130 is pivotally mounted inside the enclosure adjacent the internal wall 140. In this embodiment, the hollow tube 130 is mounted on a pivot axis 150 that extends between the internal wall 140 and a sidewall 108 of the enclosure.

FIG. 3 is a perspective view of the hollow tube 130 that is pivotally mounted in the enclosure. In this embodiment, the hollow tube has a square or rectangular cross-sectional shape. However, in alternate embodiments the tube 130 could have other cross-sectional shapes, such as a round or oval cross-sectional shape.

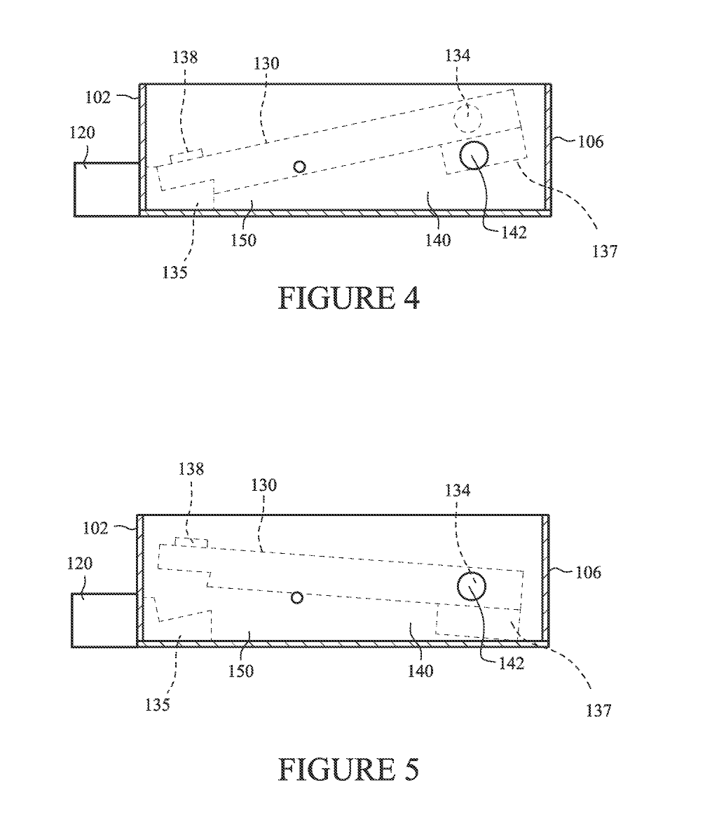

A first end of the tube 130 has an opening 132 so that snakes and small animals can pass into the interior of the hollow tube 130. A cut-out portion 131 is provided on the bottom of the first end of the tube 130. As will be explained below, the cut-out portion 131 mates with a non-moving entrance ramp 135, which is illustrated in FIGS. 4 and 5.

In some embodiments, the second opposite end of the tube 130 is closed. In addition, an exit aperture 134 is formed adjacent the second end of the tube 130. In this embodiment, the exit aperture is located on a sidewall of the tube 130. However, in alternate embodiments the exit aperture may be located in different locations. A shield 137 is provided on a bottom of the second end of the tube 130 at a location below the exit aperture 134. This embodiment also includes a weighted element 138 that is that mounted on the top of the first end of the tube 130.

FIGS. 4 and 5 are cross-sectional views taken along Section Line IV-IV in FIG. 2. FIGS. 4 and 5 illustrate how the hollow tube 130 can pivot between a first tilted position, as illustrated in FIG. 4, and a second tilted position, as illustrated in FIG. 5. FIGS. 4 and 5 illustrate the hollow tube 130 in dashed lines because it is positioned behind the internal wall 140.

As shown in FIG. 4, a holding area aperture 142 is formed in the internal wall 140 at a location adjacent the second end of the hollow tube 130. In this embodiment, the hollow tube 130 is mounted on top of the pivot axis 150 so that the hollow tube 130 can pivot around the pivot axis 150.

The weighted element 138 on the top of the hollow tube 130 presses the first end of the hollow tube 130 downward so that the hollow tube 130 is normally in the first tilted position. When in this position, the first end of the hollow tube 130 mates with a non-moving entrance ramp which extends upward and inward from the entrance aperture 112 formed in the front wall 102 of the enclosure, as illustrated in FIG. 1. The non-moving entrance ramp is enclosed to form a tube, similar in shape to the hollow tube 130. As a result, it is possible for a snake or a small animal to move through the entrance aperture 112, along the non-moving entrance ramp, and into the interior of the hollow tube 130.

As the snake or small animal moves further into the hollow tube 130, the snake or small animal will approach the second end of the hollow tube 130. The weight of the snake or small animal at the second end of the hollow tube 130 ultimately overcomes the downward force generated by the weighted element 138, and the hollow tube pivots to the second tilted position illustrated in FIG. 5. When this occurs, the exit aperture 134 on the sidewall of the hollow tube 130 aligns with the holding area aperture 142 formed in the internal wall 140. This allows the snake or small animal to move into the holding area 135 illustrated in FIG. 2.

Once the snake or small animal moves out of the hollow tube 130 and into the holding area 135, the weight of the snake or small animal will no longer hold the hollow tube 130 in the second tilted position illustrated in FIG. 5. As a result, the force provided by the weighted element 138 causes the hollow tube 130 to pivot back to the first tilted position illustrated in FIG. 4. And because the exit aperture 134 of the hollow tube 130 is then no longer aligned with the holding area aperture 142 in the internal wall 140, it is impossible for the snake or small animal to get back into the hollow tube 130 and out of the trap. Also, when the hollow tube is located in the first tilted position, as illustrated in FIG. 4, the shield 137 on the bottom of the hollow tube 130 blocks the holding area aperture 142. Thus, the snake or small animal will be trapped in the holding area 135 of the enclosure.

In the embodiment described above, the hollow tube 130 was mounted on a pivot axis 150 that passes under the hollow tube 130, and which is located closer to the first end of the hollow tube 130 than the second end. In alternate embodiments, the pivot axis could be located at other positions.

Also, in the embodiment described above, the weighted element 138 is located on the top of first end of the hollow tube. In alternate embodiments, the weighted element could be located at different positions. Or, in some instances, a weighted element may not even be needed.

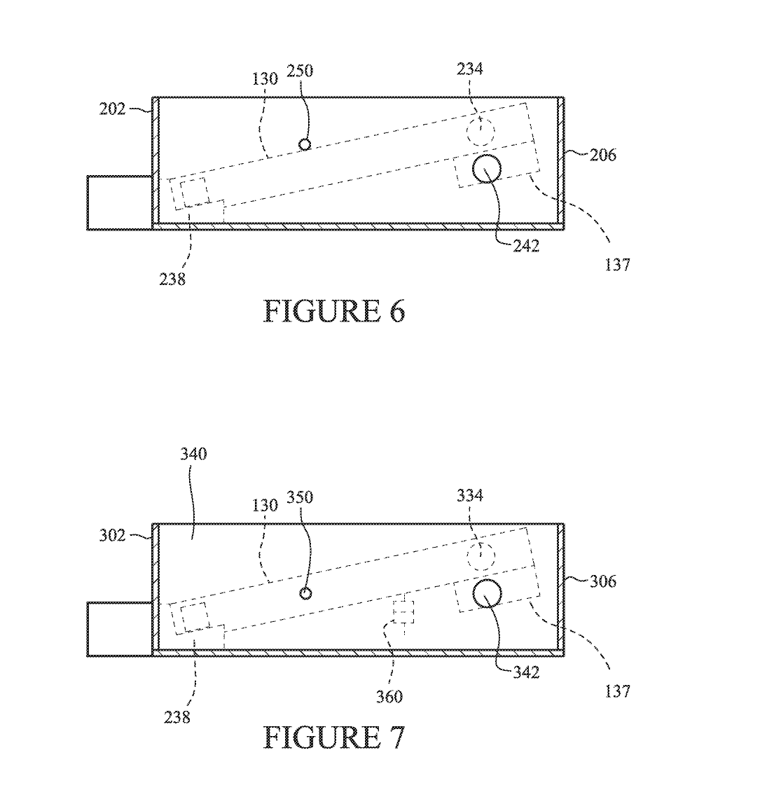

FIG. 6 illustrates a first alternate embodiment. In this embodiment, the pivot axis 250 is located over the top of the hollow tube 230. Also, the weighted element 238 is located on a sidewall of the hollow tube 230. This arrangement still allows the hollow tube to pivot between a first tilted position, as illustrated in FIG. 6, and a second tilted position in which an exit aperture 234 on the hollow tube 230 aligns with a holding area aperture 242 on the internal wall 240.

In still other embodiments, the weighted element could be located underneath the hollow tube, or at various different alternate locations on the hollow tube.

Also, in an alternate embodiment the weighted element might not even be necessary. If the position of the pivot axis is shifted so that it slightly closer to the second end of the hollow tube (which has the exit aperture) than the first end of the hollow tube, gravity alone would cause the hollow tube 130 to assume the first tilted position in which the open first end of the hollow tube aligns with the entrance aperture on the front wall of the enclosure. When a snake or small animal enters and moves along the hollow tube to the second end of the hollow tube, the weight of the snake or small animal would cause the hollow tube to assume the second tilted position, so that the exit aperture in the hollow tube aligns with the holding area aperture in the internal wall. And once the snake or small animal exits the hollow tube and enters the holding area, gravity alone would again cause the hollow tube to return to the first tilted position.

In still other alternate embodiments, as illustrated in FIG. 7, a biasing element 360 could replace the weighted element as a means for causing the hollow tube to return to the first tilted position. FIG. 7 illustrates that a biasing element 360 is connected between the floor of the enclosure and the bottom of the hollow tube 330. The biasing element could be a spring or an elastic element that pushes the hollow tube toward the first tilted position illustrated in FIG. 7.

With an embodiment as illustrated in FIG. 7, the weight of a snake or small animal moving along the hollow tube 330 toward the second end of the hollow tube 330 will ultimately overcome the force provided by the biasing element 360 so that the hollow tube pivots to the second tilted position and the exit aperture 334 aligns with the holding area aperture 342. Once the snake or small animal exits the hollow tube 330 and enters the holding area, the biasing element 360 would push the hollow tube 330 back into the first tilted position.

Although FIG. 7 illustrates the biasing element 360 providing a pushing force, and being connected between a floor of the enclosure and the bottom of the hollow tube 330, in alternate embodiments the biasing element could be connected in different ways. For example, the biasing element could be attached between the ceiling of the enclosure and the top of the hollow tube, in which case the biasing element would provide a pulling force, not a pushing force. Of course, the biasing element could be connected in many other ways, as will be appreciated by those of ordinary skill in the art.

FIG. 7 also illustrates that the pivot axis 350 is attached to sidewalls of the hollow tube 330. This could mean that the pivot axis extends from the sidewalls of the hollow tube 330, or that the pivot axis 350 passes through the hollow tube 330.

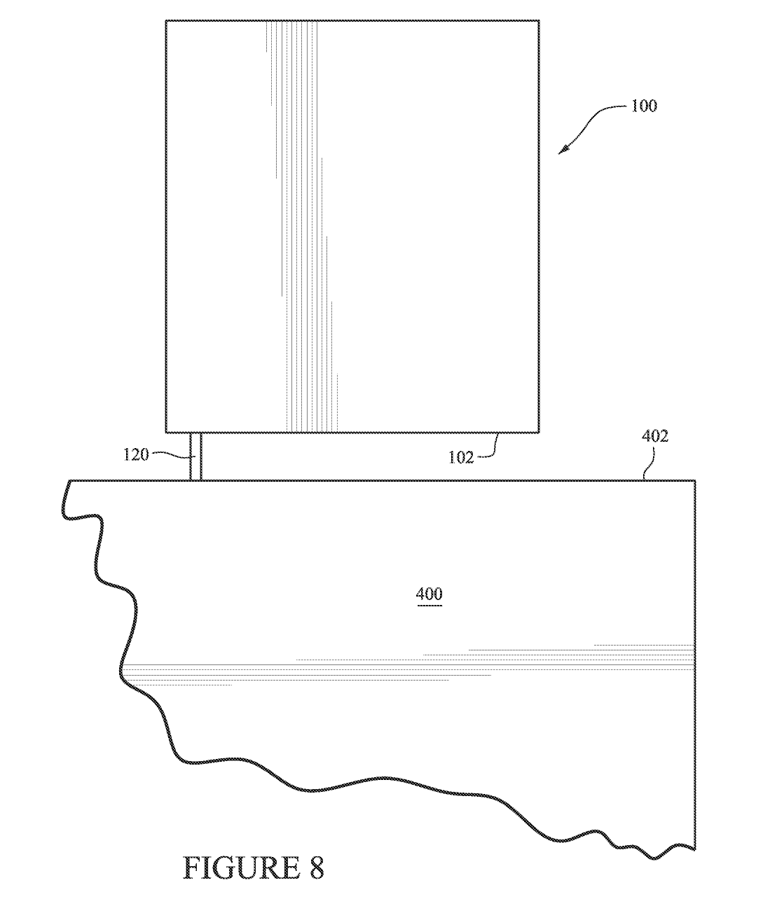

FIG. 8 illustrates one way that a trap embodying the invention could be positioned adjacent the wall 402 of a building 400. As illustrated in FIG. 8, the trap 100 is located adjacent to, but not in contact with, the wall 402 of the building 400. The front wall 102 of the trap 100 is parallel to the wall 402, forming a space that allows a snake or a small animal to travel between the trap 100 and the wall 402. In addition, the guide plate 120 of the trap 100 is extended so that it contacts the wall 402 of the building 400.

When the trap is arranged as illustrated in FIG. 8, a snake or small animal traveling along the space between the wall 402 and the front sidewall 102 of the trap 100 will ultimately encounter the guide plate 120, which prevents further forward motion. However, when it encounters the guide plate 120, the snake or small animal will be right in front of the entrance aperture 112 in the front wall 102 of the trap 100. Rather than attempt to turn around and retrace its path, the snake or small animal will be inclined to move through the entrance aperture 112 and into the open end 132 of the pivotally mounted hollow tube 130 inside the trap. Which will ultimately lead the snake or small animal into the holding area of the trap, as described above.

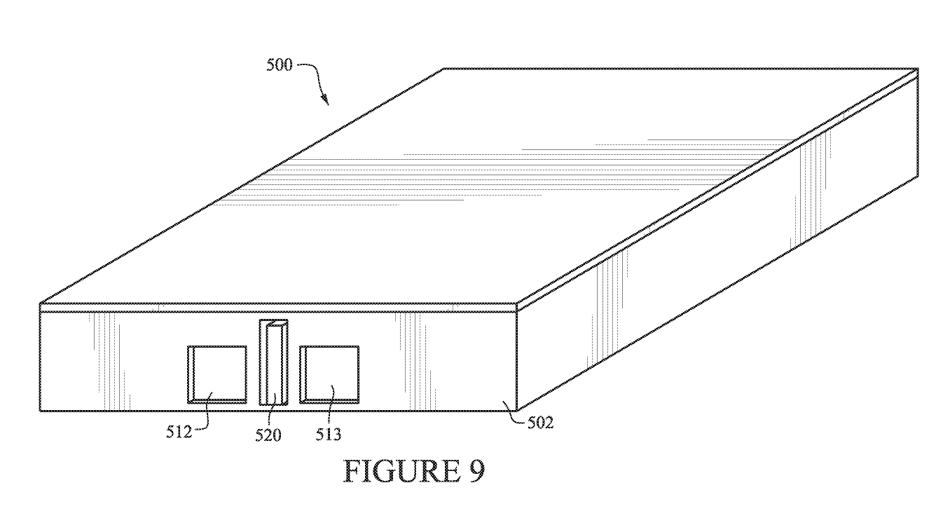

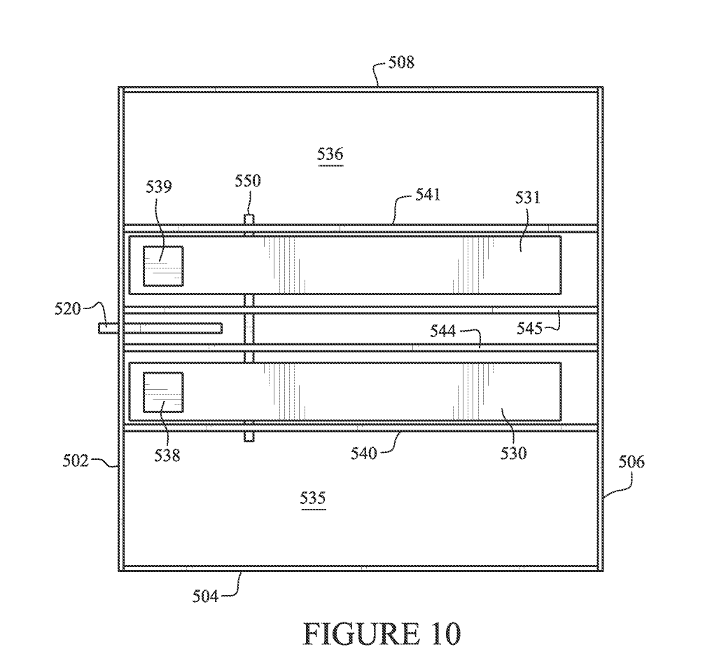

FIGS. 9 and 10 illustrate another alternate embodiment of a trap 500. In this embodiment, two entrance apertures 512 and 513 are located in the front wall 502 of the trap 500. A retractable guide plate 520 is located between the entrance apertures 512, 513.

FIG. 10 shows the interior of this embodiment, with the ceiling of the trap 500 removed. As illustrated in FIG. 10, a first interior wall 540 and sidewalls 502, 504, 506 of the trap 500 form a first holding area 535. A second interior wall 541 and sidewalls 502, 506, 508 of the trap 500 form a second holding area 536.

A first hollow tube 530 and a second hollow tube 531 are pivotally mounted on a pivot axis 550. Weighted elements 538, 539 are provided on the first and second hollow tubes, respectively. This embodiment also includes a first internal partition 544 and a second internal partition 545, although the internal partitions are not required. In this embodiment, the first and second hollow tubes would pivot between first tilted positions and second tilted positions as described above.

When a trap as illustrated in FIGS. 9 and 10 is positioned adjacent the wall of a building in a manner as shown in FIG. 8, a snake or small animal traveling from either end of the trap toward the center of the trap will encounter the guide plate 520 and be guided into one of the entrance apertures of the trap.

Once a snake or small animal has been captured in the holding area of a trap embodying the invention, it is still necessary to get the snake or small animal back out. This could be accomplished in many different ways.

In some embodiments, the ceiling of the enclosure could be removably attached to the sidewalls. In some embodiments, the ceiling could be hinged to the remainder of the trap so that the ceiling could be pivoted open to access one of the holding areas. In alternate embodiments, the ceiling could simply rest on the top of the trap, and the weight of the ceiling would be sufficient to prevent any trapped snakes or animals from escaping. In still other embodiments, the ceiling could be latched to the remainder of the trap.

In still other embodiments, a portion of a side wall that bounds a holding area could be hinged in place, as illustrated in FIG. 2. FIG. 2 shows that a door 116 is attached to the sidewall 106 by a hinge 117. A latch 118 keeps the door closed until it is desirable or necessary to open the trap.

In alternate embodiments, a door or slidable panel could be provided on other portions of the trap to allow access to the holding area of the trap, as will be apparent to those of ordinary skill in the art.

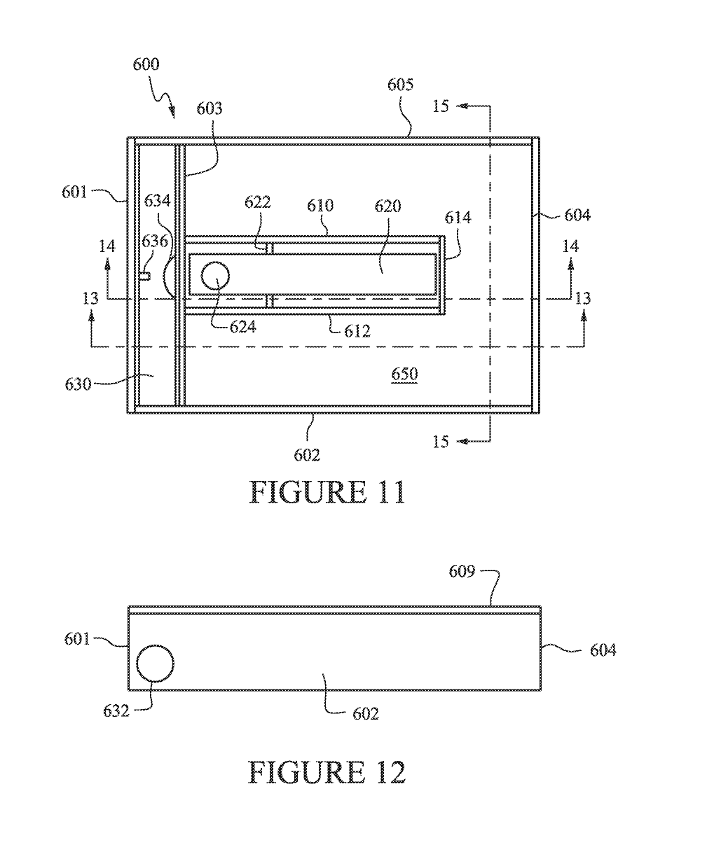

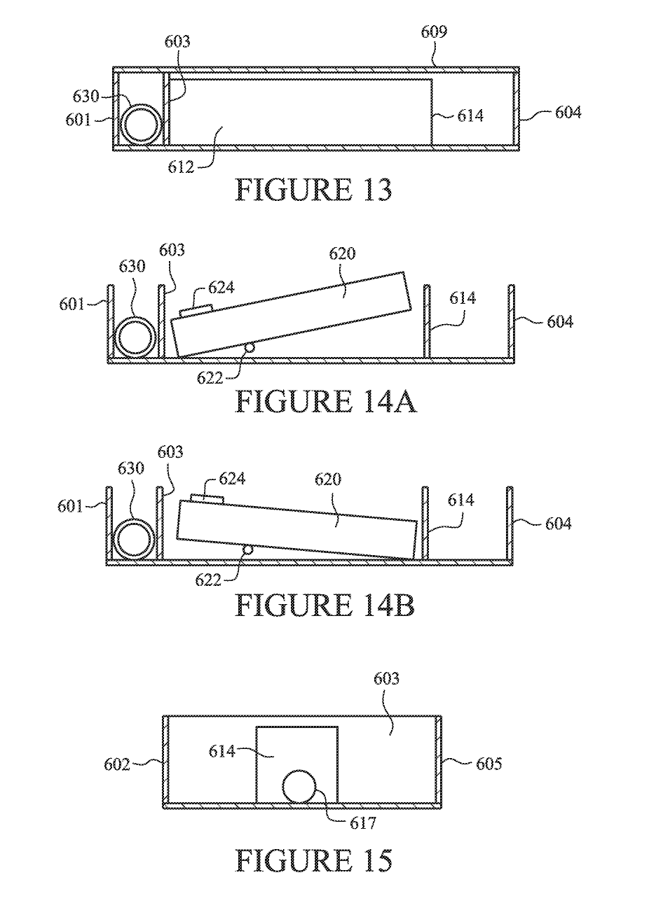

FIGS. 11-15 depict another embodiment of a trap which operates on principles similar to the traps disclosed above. In this embodiment, the trap 600 includes a front wall 601, a rear wall 604 and sidewalls 602, 605. A circular aperture 632 is cut into both sidewalls 602, 605. The apertures 632 open into a cylindrical tube 630 that is mounted between an inner side of the front wall 601 and an intermediate wall 603. Thus, a snake or small animal could enter the cylindrical tube 630 from either side of the trap.

An inner housing is located inside the trap 600. The inner housing includes a first sidewall 610, a second sidewall 612 and an end wall 614. The inner housing adjoins the intermediate wall 603. A pivoting tube 620 is pivotally mounted inside the inner housing. The pivoting tube is open at both ends and pivots about an axis 622. A weight 624 is mounted at a first end of the pivoting tube. The weight biases the first end of the tube downward. As a result, in the absence of external forces, the pivoting tube 620 will assume the position illustrated in FIG. 14A.

A circular aperture is cut into the intermediate wall 603 at a position that registers with the first end of the pivoting tube 620 when it is in the position illustrated in FIG. 14A. Also, an aperture 634 is cut in the cylindrical tube 630 at essentially the same position. As a result, a snake or small animal that has entered the cylindrical tube 630 via one of the apertures 632 on the sidewalls 602, 605 of the trap can pass from the interior of the cylindrical tube 630 into the pivoting tube 620.

Once a snake or small animal has entered the pivoting tube 620 and begins moving toward a second end of the pivoting tube, the weight of the snake or small animal will cause the pivoting tube 620 to pivot about the axis 622 until the pivoting tube assumes the position illustrated in FIG. 14B.

As depicted in FIG. 15, a circular aperture 617 is cut in the end wall 614 of the inner housing. When pivoting tube is located in the position illustrated in FIG. 14B, the second end of the pivoting tube 620 registers with the circular aperture 617 of the end wall 614 of the inner housing, which allows the snake or small animal to exit the pivoting tube and enter a holding area 650 of the trap 600.

Once the snake or small animal has exited the pivoting tube 620 and arrived in the holding area 650, the weight 624 on the first end of the pivoting tube will cause the pivoting tube to return to the position illustrated in FIG. 14A. As a result, the snake or small animal in the holding area 650 will be unable to re-enter the pivoting tube 620, and the snake or small animal will be trapped in the holding area.

The top 609 of the trap is removably attached to the remainder of the trap 600. As a result, a user can ultimately remove the top 609 to remove captured snakes and small animals from the holding area 650.

A baffle or guide 636 may be positioned in an interior of the cylindrical tube 630, as illustrated in FIG. 11. The baffle or guide 636 can serve to direct a snake or small animal into the pivoting tube 620, to prevent a snake or small animal that enters one end of the cylindrical tube 630 from simply passing straight along the cylindrical tube and exiting from the opposite side of the trap.

In the foregoing embodiment, the cylindrical tube 630, and the pivoting tube 620 have circular cross-sectional shapes. However, in alternate embodiments, these elements could have different cross-sectional shapes, such as square or rectangular shapes. If a different cross-sectional shape is provided, the apertures 632 on the sidewalls 602, 605 and the aperture 617 in the end wall 614 of the inner housing could be shaped to match.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A trap for catching and holding snakes and small animals, comprising:
an enclosure including a floor, a ceiling and sidewalls, wherein an entrance aperture is located in a wall of the enclosure;
an elongated, hollow tube, wherein first and second ends of the tube are open, wherein the tube is pivotally mounted inside the enclosure so that the tube can pivot between a first tilted position and a second tilted position, the tube being positioned inside the enclosure so that when the tube is in the first tilted position, the first open end of the tube aligns with the entrance aperture in the enclosure; and
an internal wall that is mounted inside the enclosure adjacent the tube, wherein a holding area aperture is located in the internal wall, wherein when the tube is in the second tilted position, the second open end of the tube aligns with the holding area aperture in the internal wall, and wherein when the tube is in the first tilted position, the second open end of the tube does not align with the holding area aperture.

2. The trap of claim 1, wherein the second open end of the tube comprises an exit aperture that is located on a sidewall of the tube adjacent the second end of the tube.

3. The trap of claim 2, wherein a longitudinal axis of the internal wall is substantially parallel to a longitudinal axis of the tube and wherein the internal wall is located in the enclosure so that it is closely adjacent to the sidewall of the tube.

4. The trap of claim 3, wherein the internal wall and sidewalls of the enclosure form a holding area, and wherein when the tube is in the first tilted position, the internal wall covers the second open end of the tube to prevent a snake or a small animal located in the holding area from escaping the holding area through the tube.

5. The trap of claim 1, wherein the tube is mounted and configured such that when the trap is laying on a flat surface, gravity causes the tube to assume the first tilted position.

6. The trap of claim 1, wherein the tube includes a weighted element that is positioned on the tube such that when the trap is laying on a flat surface, gravity causes the tube to assume the first tilted position.

7. The trap of claim 1, further comprising a biasing member that is connected between the enclosure and the tube, wherein the biasing member applies a force to the tube that biases the tube towards the first tilted position.

8. The trap of claim 1, wherein the ceiling of the enclosure is removably coupled to the sidewalls.

9. The trap of claim 1, wherein the enclosure includes a door that can be opened to access an interior of the enclosure.

10. The trap of claim 1, further comprising a guide plate that is retractably mounted on a sidewall of the enclosure, wherein the guide plate is movable between a retracted position in which it is located inside the enclosure and an extended position in which a portion of the guide plate extends from the enclosure.

11. The trap of claim 10, wherein the guide plate is located adjacent the entrance aperture.

12. The trap of claim 1, further comprising a pivot axis that is mounted on an internal wall of the enclosure, and wherein the tube is pivotally mounted on the pivot axis.

13. The trap of claim 1, wherein a shield is provided on a second end of the hollow tube at a location adjacent the second end of the tube such that when the hollow tube is in the first tiled position, the shield is aligned with the holding area aperture.

14. The trap of claim 13, wherein the shield extends from a bottom of the hollow tube at a location beneath the exit aperture.

15. The trap of claim 1, further comprising an entrance ramp that is positioned inside the enclosure and adjacent the entrance aperture, the entrance ramp including a sloped surface that aligns with a bottom surface of the hollow tube when the hollow tube is in the first tilted position.

16. The trap of claim 15, wherein a cut-out is formed on a lower portion of the first end of the hollow tube, the cutout portion mating with the entrance ramp when the hollow tube is in the first tilted position.

17. The trap of claim 15, wherein the entrance ramp forms an enclosure having a shape that matches a shape of the hollow tube.
